(19) United States
(12) Patent Application Publication
(10) Pub. No.: US 2024/0361753 A1
(43) Pub. Date: Oct. 31, 2024

(54) Sequential Behavior for Intelligent Control in Subsumption-Like Architecture

(71) Applicants: Telefonaktiebolaget LM Ericsson (publ), Stockholm (SE); Ericsson Telecomunicações LTDA, Sao Paulo (BR)

(72) Inventors: Ricardo Ribeiro Gudwin, Campinas - SP (BR); Klaus Raizer, Indaiatuba (BR); Swarup Kumar Mohalik, Bangalore Karnataka (IN); Aneta Vulgarakis Feljan, Stockholm (SE); Wandemberg Santana Pharaoh Gibaut, Campinas - SP (BR)

(21) Appl. No.: 18/683,830

(22) PCT Filed: Aug. 17, 2022
(86) PCT No.: PCT/EP2022/072962

§ 371 Date: Feb. 15, 2024

(30) Foreign Application Priority Data
Aug. 20, 2021 (IN) 202141037757

(51) Int. Cl. G05B 19/4155

(52) U.S. Cl. CPC G05B 19/4155; G05B 2219/34012

(57) ABSTRACT

A method for controlling operation of a system that interacts with an environment includes obtaining, by a plurality of sequential behavioral nodes, a plurality of plans for controlling the system, each plan comprising a sequence of activities to be performed by the system; selecting one of the respective plans for execution based on relative priorities of the sequential behavioral nodes; and executing the selected plan. Related subsumption-based controllers are also disclosed.

### TECHNICAL FIELD

The present disclosure relates to intelligent control systems, and in particular, to a control method and a controller for controlling a system that interacts with an environment.

### BACKGROUND

The subsumption architecture is a generic name for a family of computational architectures used in intelligent control of systems (particularly in robotics) which gave rise to the field of behavior-based robotics. The subsumption architecture was developed in the context of mobile robotics in an attempt to overcome limitations of the traditional approach to the use of artificial intelligence (AI) for robot control. Although developed in the context of robotics, the principles of subsumption-based control can apply to many other kinds of systems, such as communication systems, manufacturing systems, etc.

According to the traditional operational cycle of an intelligent control system following the AI paradigm, illustrated in FIG. 1, information used to control a system is processed in a pipelined fashion in which sensor data is first processed by a perception module. The perceived data is then processed by a modeling module to generate a model of the environment. This model is then used by a planning module that generates a plan (i.e., a sequence of desired actions). The plan is processed by a task execution module which generates control signals that are processed by a motor control module. The motor control module generates motor command signals that are sent to system actuators.

Although the traditional control paradigm illustrated in FIG. 1 may be adequate for simple applications, the traditional architecture lacks scalability. When the number of considered behaviors in a system starts to increase, the system complexity grows rapidly, and the control cycle becomes infeasible.

Alternatively, instead of a serial pipeline, Professor Rodney Brooks proposed a parallel strategy for system control, referred to as the subsumption architecture illustrated generally in FIG. 2, in which a plurality of independent, parallel behaviors are defined. Information from sensors is provided to each behavior, and the system determines which behavior to execute based on a priority system. That is, each behavior competes to control the robot's actuators, with the highest priority behavior gaining control. As shown in FIG. 2, the behaviors may include tasks or goals, such as “avoid objects”, “wander”, “explore”, “identify objects”, etc. For clarity, a behavior is a sequence, or group, of actions that brings the agent closer to achieving a specific general goal, given its internal state and information from sensors. Activating a behavior means that a particular set of actions will be performed. For instance, the ‘wander’ behavior in FIG. 2 means that the robot agent would have actions for wheel speed performed according to information from the sensors in order to achieve such wandering-around behavior.

In the subsumption architecture, new behaviors can be developed in isolation and can be integrated into the overall architecture. In the original proposal by Brooks, each behavior is represented by a finite state machine, which may be augmented with instance variables. Each behavior is assigned a priority level from lowest to highest, where the output of a higher priority behavior subsumes the output of a lower priority behavior. Moreover, higher priority behaviors can send bias signals to lower priority behaviors to affect their inputs. This architecture is illustrated in FIG. 3. As shown therein, each behavior receives sensor inputs and generates corresponding outputs, and higher priority behaviors can send bias signals to lower priority behaviors to affect their outputs.

One shortcoming of the classical subsumption architecture is that nodes have fixed dominant and non-dominant characteristics. This means that once a behavior is placed in a higher level, it will always have priority in setting up its behavior relative to lower priority behaviors. Even though this may be desirable in some situations, it is possible that in some situations an established priority relationship should be inverted. This is not possible in the classical subsumption architecture. To deal with this difficulty, some researchers have proposed a dynamical subsumption scheme in which there is no fixed dominant input. That is, the dominance hierarchy of behaviors can be changed dynamically in time depending on the situation. There are various implementations of the dynamical subsumption model; the Multipurpose Enhanced Cognitive Architecture (MECA) is one example of an architecture using a dynamical subsumption model.

FIG. 4 illustrates an example topology of a dynamical subsumption model in which a plurality of behavior nodes 402, representing different behaviors, generate outputs (x_{N}, e_{N}) wherein ‘N’ is a positive integer, which are provided to a selector node 404. The outputs x_{N} represent the control outputs generated by the behavior nodes 402, while the outputs e_{N} represent the output of evaluation functions that are calculated based on current conditions. The selector node 404 determines a priority among proposed control outputs x_{N} based on the associated evaluation function outputs e_{N} and selects the highest priority control output for execution. In practice, the nodes illustrated in FIG. 4 may be implemented as micro-agents,

called codelets, which are responsible for various actions in the architecture. Codelets are small pieces of non-blocking code, each of which may execute a well-defined and simple task. “Non-blocking” means that each codelet is self-contained and will not restrict other codelets from running regardless of the processing state of the codelet. A codelet may be executed continuously and cyclically, and is responsible for the behavior of the independent components of the system running in parallel. In the MECA architecture, behaviors are implemented by means of codelets.

In the present disclosure, a “codelet” may be a process running a specific piece of non-blocking code within a computer, or at an arbitrary location of a computing device in the network. For simplicity, the term “node” is used herein to refer to an independent component of a subsumption architecture that executes a codelet.

There currently exist certain challenge(s). The subsumption architecture was developed to bring flexibility to control systems. It created a new paradigm for the generation of system behaviors, in which behaviors compete for control of the system. This opened a new field of research, called behavior-based robotics. Despite the fact that the subsumption architecture allowed improved flexibility and scalability for system control, it also created some difficulties for certain types of systems. For example, in some systems, it is desirable for the robot (or other device or system being controlled) to follow a plan-based strategy. However, using the subsumption architecture, all behaviors are emergent, i.e., they emerge based on unpredictable changes in the environment and based on the perceived situation, and are thus themselves unpredictable.

While this property may be useful for dealing with unpredictable changes in the environment, it may cause difficulties in dealing with situations where an expected behavior or sequence of behaviors is desired. That is, in a system that employs a classic subsumption architecture, all behaviors are emergent. However, there are situations in which it is desirable for the system to engage in a sequence-based series of behaviors.

### SUMMARY

Some embodiments provide a subsumption-based controller for controlling operation of a system that interacts with an environment. The subsumption-based controller includes a plan execution subsystem including a plurality of sequential behavioral nodes, each configured to generate a respective plan for controlling the system, a plan selector node configured to select one of the respective plans for execution,, and an activity selection subsystem that receives the selected plan and executes the selected plan.

Each respective plan includes a sequence of activities to be performed by the system. The plan selector node selects the one of the respective plans for execution based on relative priorities of the sequential behavioral nodes.

The activity selection subsystem includes a plurality of activity nodes, at least one of the activity nodes being associated with an activity in the sequence of activities included in the selected plan. In response to the plan, the at least one of the activity nodes generates a control signal for controlling an actuator of the system to perform the associated activity.

The subsumption-based controller may further include an activity tracking node that receives the selected plan, identifies a current activity that is being performed by the system, and transmits the identity of the current activity to the activity selection subsystem.

The activity selection subsystem may include an activity selector node that receives control signals from a plurality of the activity nodes, selects one of the control signals based on relative priorities of the activity nodes, and applies the selected control signal to the actuator.

The subsumption-based controller may further include a planning subsystem that receives plan requests from the sequential behavioral nodes, generates plans in response to the plan requests, and transmits the generated plans to the sequential behavioral nodes.

The subsumption-based controller may further include a plan request selector node. The sequential behavioral nodes submit respect plan requests to the plan request selector node, and the plan request selector node selects one of the plan requests and submits the selected plan request to the planning subsystem.

In some embodiments, the plan request selector node selects a plan request for submission to the planning subsystem based on relative priorities of the sequential behavioral nodes.

In some embodiments, the relative priorities of the sequential behavioral nodes are established at run time. In some embodiments, the system includes a robotic system, a manufacturing system and/or a communication system. The actuator may include a motor. In some embodiments, the subsumption-based controller is embedded within the system.

Some embodiments provide a method for controlling operation of a system that interacts with an environment. The method includes obtaining, by a plurality of sequential behavioral nodes, a plurality of plans for controlling the system, each plan including a sequence of activities to be performed by the system, selecting one of the respective plans for execution based on relative priorities of the sequential behavioral nodes, and executing the selected plan.

Executing the selected plan may include transmitting the selected plan to an activity selection subsystem including a plurality of activity nodes, at least one of the activity nodes being associated with an activity in the sequence of activities included in the selected plan, and generating, by at least one of the activity nodes, a control signal for controlling an actuator of the system to perform the associated activity.

The method may further include identifying a current activity that is being performed by the system, and transmitting the identity of the current activity to the activity nodes.

The activity selection subsystem may include an activity selector node that receives control signals from a plurality of the activity nodes, selects one of the control signals based on relative priorities of the activity nodes, and applies the selected control signal to the actuator.

The method may further include generating plans in response to plan requests from the sequential behavioral nodes, and transmitting the generated plans to the sequential behavioral nodes.

The method may further include receiving the plan requests from the sequential behavioral nodes at a plan request selector node, selecting one of the plan requests, and submitting the selected plan request to a planning subsystem.

In some embodiments, selecting a plan request includes selecting a plan request for submission to the planning system based on relative priorities of the sequential behavioral nodes.

In some embodiments, the relative priorities of the sequential behavioral nodes are established at run time.

### BRIEF DESCRIPTION OF THE DRAWINGS

FIG. 1 illustrates a traditional operational cycle of an intelligent control system.

FIG. 2 illustrates a strategy for system control for a subsumption architecture for an intelligent control system.

FIG. 3 illustrates a subsumption architecture for an intelligent control system.

FIG. 4 illustrates an example topology of a dynamical subsumption model.

FIG. 5 illustrates architecture for a dual-layer subsumption control system according to some embodiments.

FIG. 6 illustrates data structures used by various elements of a subsumption control system according to some embodiments.

FIG. 7 illustrates expected inputs and outputs of sequential behavioral nodes, activity nodes and an activity tracking node of a subsumption control system according to some embodiments.

FIG. 8 illustrates an example application of a dual-layer subsumption control system according to some embodiments.

FIG. 9 is a sequence diagram that illustrates operations of various nodes within a dual-layer subsumption control system according to some embodiments.

FIG. 10 illustrates operations of a dual-layer subsumption control system including two sequential behavioral nodes, two activity nodes and one motor memory according to some embodiments.

FIG. 11 illustrates some aspects of a subsumption controller that may be used to implement the dual-layer subsumption control system according to some embodiments.

FIG. 12 illustrates various functional modules that may be stored in a memory of a subsumption controller according to some embodiments.

FIGS. 13A to 13C illustrate various ways in which a dual-layer subsumption controller according to some embodiments can be deployed to control a controlled system within an environment.

FIG. 14 is a flowchart illustrating operations of a control system according to some embodiments.

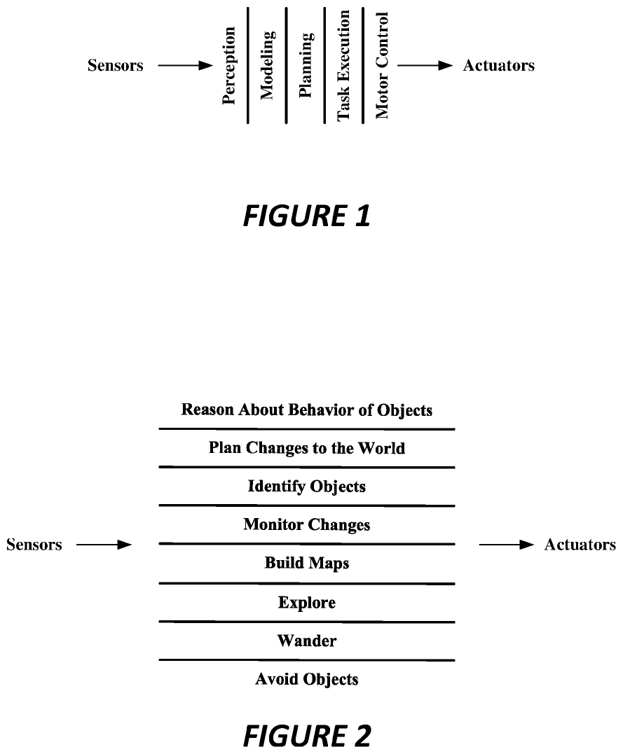

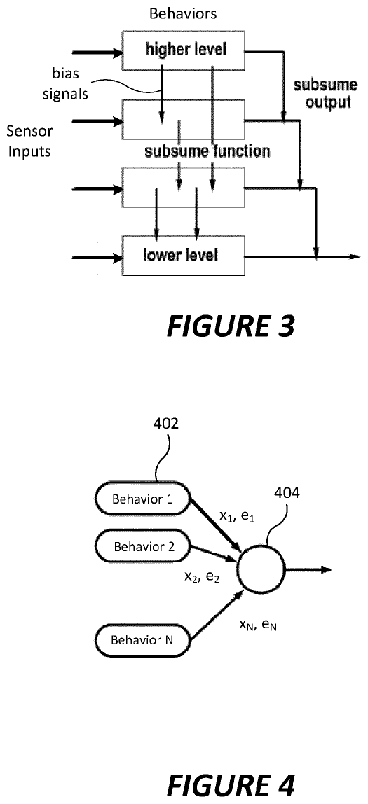

### DESCRIPTION OF EMBODIMENTS

As noted above, in s traditional subsumption-based architecture, all behaviors are emergent. While this property may be useful for dealing with unpredictable changes in the environment, it may cause difficulties in dealing with situations where an expected behavior or sequence of behaviors is desired. To overcome this shortcoming, some embodiments described herein provide a hybrid technique that may provide both the flexibility of a subsumption architecture with the ability to execute specific sequences of behaviors, in certain situations, as was provided by conventional AI approaches to system control.

Certain aspects of the disclosure and their embodiments may provide solutions to these or other challenges. In particular, a dual-layer control system/method according to some embodiments provides two subsumption architectures that cooperate to generate control signals. The behavior nodes of a classic subsumption architecture are split into two sub-groups, referred to as sequential behavioral nodes and activity nodes. In this model, the sequential behavioral nodes are responsible for high-level behaviors, expressed as plans, and the activity nodes are responsible for performing simple tasks or activities, which can be performed to execute a selected plan. Depending on the situation, the activity nodes could be used in a classic subsumption-like behavior, where all behavior is emergent. However, in situations where a sequential behavior is necessary, the sequential behavioral nodes may be used to provide a sequential plan to be executed by the activity nodes.

Some embodiments provide a two-level subsumption system. In the first level, complete sequences of behavior, expressed as plans generated by or for sequential behavioral nodes, compete for control of the second level in a manner similar to the classic subsumption architecture. The behavior that wins the first level is then used to coordinate a lower-level subsumption sub-system. That is, the activities in the lower-level now compete to execute the winning plan. However, the activity needed to execute the plan must compete, at the lower-level, with other simple activities, which could be selected if there are changes in the environment that indicate that following the plan is no longer the best choice. That is, in the two-level subsumption system, the ultimate result might be either to follow specific sequences of behavior defined in the plan, or to engage in a non-planned activity based on unexpected changes in the environment.

Some embodiments may be described as providing a system/method that allows sequential behavior (i.e., the system follows a known sequence of lower-level activities) along with normal emergent behavior of single lower-level activities in intelligent systems with subsumption architectures of control. Some embodiments may be further described as providing a control system including two levels of subsumption sub-systems, namely, a higher level that generates a desired sequential behavior, and a lower-level that implements the sequential behavior through simple activities that compete for control over system actuators.

Certain embodiments may provide one or more technical advantages. In particular, some embodiments described herein may be able to take advantage of both the flexibility and scalability provided by the standard dynamical subsumption architecture, while also allowing and/or causing a predefined specific sequence of behaviors to be executed as a result of the two-level subsumption system/method described herein.

Some of the embodiments contemplated herein will now be described more fully with reference to the accompanying drawings. Embodiments are provided by way of example to convey the scope of the subject matter to those skilled in the art.

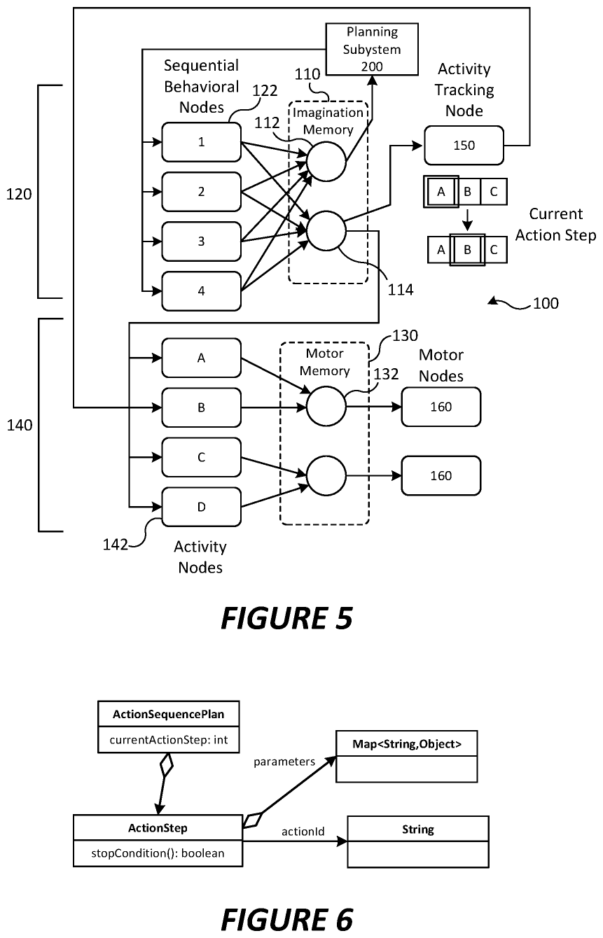

An architecture for a dual-layer subsumption control system 100 is illustrated in FIG. 5. The control system 100 includes two principal subsystems, namely, a plan execution subsystem 120 and an activity selection subsystem 140. The plan execution subsystem 120 includes sequential behavioral nodes 122, an imagination memory 110 and an activity tracking node 150. The activity selection subsystem 140 includes a plurality of activity nodes 142, along with one or more motor memories 130 which respectively control one or more actuators, or motor nodes 160. An optional planning subsystem 200 may be provided in addition to the plan execution subsystem 120 and the activity selection subsystem 140.

In the context of a robotic system, the actuators 160 may include DC motors, linear actuators, or other transducers that allow the robot to move and interact with an environment. In other types of systems, the actuators 160 may include communication devices, heating devices, steering devices, or any other controllable device that allows a system to act on an environment.

In a conventional MECA architecture, behaviors are generated by behavioral nodes, which are dynamically subsumed depending on activations coming from perception (sensor) and drive (motor) inputs. These behaviors may work in parallel, such as if they are feeding different motor memories, or they might compete based on activations if more than one behavior node feeds the same motor memory. In that case, the behavior with the highest activation wins the competition and modifies the motor memory, which becomes the input of a motor node for actuation. Accordingly, in the conventional MECA architecture, each behavior node directly generates an actuation output.

The sequential behavioral nodes 122 used in the dual-layer subsumption control system 100 are different from conventional MECA behavior nodes, because rather than generating actuation values for motor nodes, the sequential behavioral nodes 122 generate plans and/or plan requests, where a “plan” is a sequence of action steps that need to be taken to accomplish a predetermined task or goal. Each action step may receive parameters associated with the action, and each action step may be associated with a different one of the activity nodes 142. The parameters might be different for each action step. Each plan also has a current action step parameter, which corresponds to the number of the current action step of a plan that is being executed. At any instant of time, the current action step drives an explicit activity among the activity nodes 142.

In some embodiments, the sequential behavioral nodes 122 may generate plans themselves. In other embodiments, plans may be generated by a separate planning subsystem 200, which generates plans at the request of the sequential behavioral nodes 122 and broadcasts the generated plans to the sequential behavioral nodes 122. In some embodiments, the sequential behavioral nodes 122 may generate and/or modify plans provided by the planning subsystem 200 based on perception and/or drive inputs. Accordingly, from time to time, a sequential behavior node 122 may modify, update or abandon an existing plan that it has created or obtained from the planning subsystem 200. The planning subsystem 200 may be implemented, for example, as a SOAR node [6] according to the conventional MECA approach.

The imagination memory 110 is a processing node that includes two selector nodes, namely, a plan request selector node 112 and a plan selector node 114. The imagination memory 110 is so-named because it functions to mimic a biological imagination—namely, to generate and select plans for future implementation. Although referred to as a “memory,” the imagination memory 110 performs processing functions and does not function only as a store of data. The imagination memory 110 receives plans output by the sequential behavioral nodes 122 and selects a plan for execution according to a subsumption-based selection approach. That is, the behavioral nodes 122 have associated priorities (which may be determined statically ahead of time or dynamically at run time), and compete for control of the activity selection subsystem 140 based on their respective priorities in a subsumption-based manner.

Likewise, the sequential behavioral nodes 122 may also compete for access to the planning subsystem 200. The sequential behavioral nodes 122 submit plan requests to the imagination memory 110. Plan requests are processed by the plan request selector node 112, which selects a plan request according to priorities of the sequential behavioral nodes 122 and submits the selected plan request to the planning subsystem 200. The planning subsystem 200 generates a plan in response to the selected plan request and broadcasts the plan to the sequential behavioral nodes 122.

An activity tracking node 150 receives the selected plan output by the plan selector node 114 and tracks the current state of the system. That is, the activity tracking node 150 keeps track of which particular activity of a selected plan is currently being executed (or proposed for execution). The activity tracking node 150 provides information about the currently selected activity to the activity nodes 142. The activity nodes 142 use the information about the currently selected activity to generate motor control commands and compete for access to the motor nodes 160 via the motor memory 130 within the activity selection subsystem 140, again using a subsumption approach.

Accordingly, within the activity selection subsystem 140, activity nodes 142 receive an indication from the activity tracking node 150 about the current action step of the selected plan that is being executed and responsively generate motor control commands for motor nodes 160. The motor control commands are provided to respective activity selector nodes 132 within the motor memory 130. For each motor node 160, the associated activity selector node 132 selects a motor control command generated by one of the activity nodes 142 based on the subsumption model, i.e., according to the (static or dynamic) priority of the activity nodes 142, and applies the selected motor control command to the motor node 160. As with the imagination memory 110, the motor memory 130 has processing capabilities and is more than simply a store of data.

FIG. 6 illustrates some examples of data structures used by various elements of the subsumption control system 100. As shown in FIG. 6, a plan is represented by an ActionSequencePlan object, which includes a list of ActionStep objects. A currentActionStep parameter identifies the action step that is currently being executed. The ActionStep has associated parameters and an action ID. It also has a stopCondition () method, which is used by the activity tracking node 150 to continuously evaluate if the conditions necessary to conclude the ActionStep have been already met, or not.

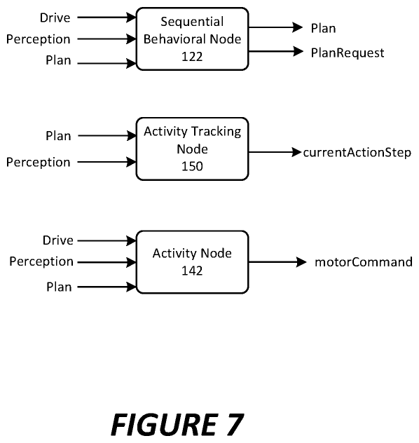

FIG. 7 illustrates the expected inputs and outputs of sequential behavioral nodes 122, activity nodes 142 and the activity tracking node 150. As shown in FIG. 7, the sequential behavioral nodes 122 receive perception and drive inputs from the control system 100 along with plan inputs from the planning subsystem 200 and generate plans and plan requests as outputs. The activity tracking node 150 receives plans and perception as inputs and generates a current action step as an output. The activity nodes 142 receive the selected plan as an input along with the perception and drive inputs from the control system 100 and generate motor commands as an output.

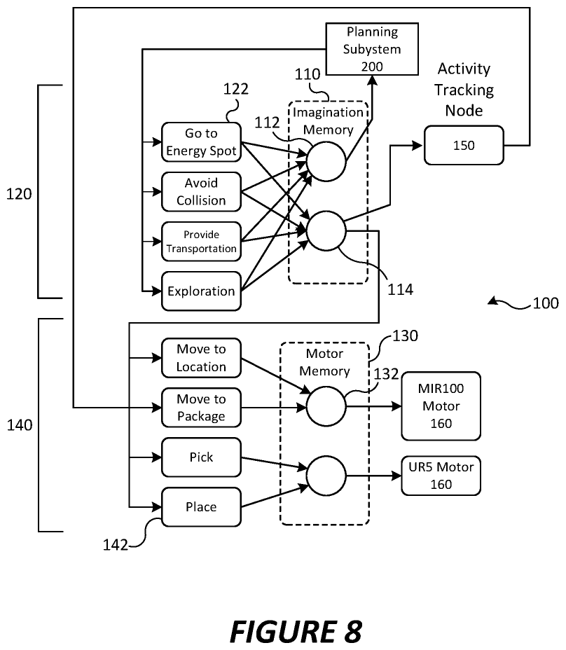

FIG. 8 illustrates an example application of a dual-layer subsumption control system 100 according to some embodiments. In particular, FIG. 8 illustrates a control system for a transportation robot that transports packages around a factory, picking them and placing them in designated shelves at the warehouse, or at designated slots in a processing cell. Although the example application shown in FIG. 8 relates to robotics, it will be appreciated that the techniques described may be applicable to any controllable system that interacts with an environment.

In the example shown in FIG. 8, there are four different kinds of sequential behavioral nodes 122, namely, a “Go to Energy Spot” node, an “Avoid Collision” node, a “Provide Transportation” node and an “Exploration” node. Each of these nodes provide plans according to different perspectives or goals. For example, the “Go to Energy Spot” node provides a plan that will move the robot from its current position, passing through different landmarks, up to a final location, an energy spot, where the robot can recharge its battery. The “Avoid Collision” node will detect a possible human passing too close to the robot, and will immediately stop the robot until the human being is once again at a safe distance from the robot. The “Provide Transportation” node generates a plan to move the robot from the current position, passing through intermediate landmarks, until approaching a package to pick. It will stop in front of the package position, pick up the package, and then move again, passing through more intermediate landmarks until reaching the package destination location. Then, the robot will approach the final package position, and place the package there. Finally, the “Exploration” node creates a plan for the robot to move around the factory, through random locations, trying to explore the factory.

All of these plans may be created using one of four different activities associated with the activity nodes, which include a “Move to Location” activity node, a “Move to Package” activity node, a “Pick” activity node and a “Place” activity node.

The “Move to Location” activity, is an activity that, given position/angle parameters (x,y,θ), will send actuator commands to move the robot to the (x,y) position, with a reaching angle θ. The “Move to Package” activity is an activity that, given a 7-tuple representing the pose of a package, will calculate the proper (x,y,θ) to stop the robot just in front of the package position, and will move the robot there. The “Pick” node is an activity that, given a 7-tuple pose of a package to pick, and an internal slot number, will move the robot arm to the identified position, pick the package and store it inside the robot in an assigned internal slot. The “Place” activity is the inverse of the “Pick” activity. Given a 7-tuple pose of the package placing position, and an internal slot number, it will pick the package from this internal slot and place it in the assigned position.

The plans defined by each sequential behavioral node 122 will compete, using a dynamic subsumption scheme as described, and the plan with the greater evaluation grade (indicating a higher priority) will be sent to the activity selection subsystem 140 for execution. The activity tracking node 150 monitors the performance of each activity, and when an activity reaches its stop condition, will change the value of currentActionStep for the selected plan to the next action step. Within the activity selection subsystem 140, each activity node 142 will check to see if the currentActionStep is its responsibility, and if so, will send appropriate commands to the motor memory.

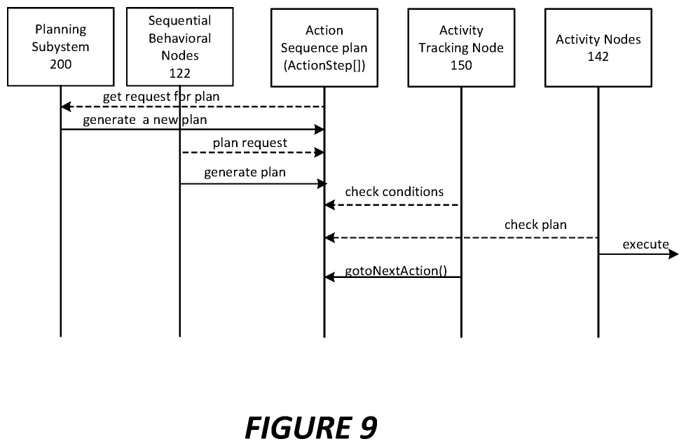

FIG. 9 is a sequence diagram that illustrates operations of various nodes within a dual-layer subsumption control system 100 according to some embodiments, including operations of a planning subsystem or planning node 200, one or more sequential behavioral nodes 122, an activity tracking node 150 and one or more activity nodes 142 In the sequence diagram of FIG. 9, the operations of various nodes are asynchronous relative to one another. For example, operations of each node may be triggered upon expiration of a timer associated with the node.

Referring to FIGS. 5 and 9, the planning subsystem 200 periodically checks for plan requests output by the plan request selector node 112 of the imagination memory 110 (FIG. 5) and generates a new plan in response to the plan request.

The sequential behavioral nodes 122 periodically check for generated plans (or generate) plans and submit the plans to the plan selector node 114 (FIG. 5).

The activity tracking node 150 periodically checks the current state of the system to determine which action step is currently being executed and, when it is determined that a stop condition has been reached, updates the current action step to the next action in the current plan.

The activity nodes 142 periodically check the current plan and the current action step and send appropriate motor control commands to the activity selector nodes 132.

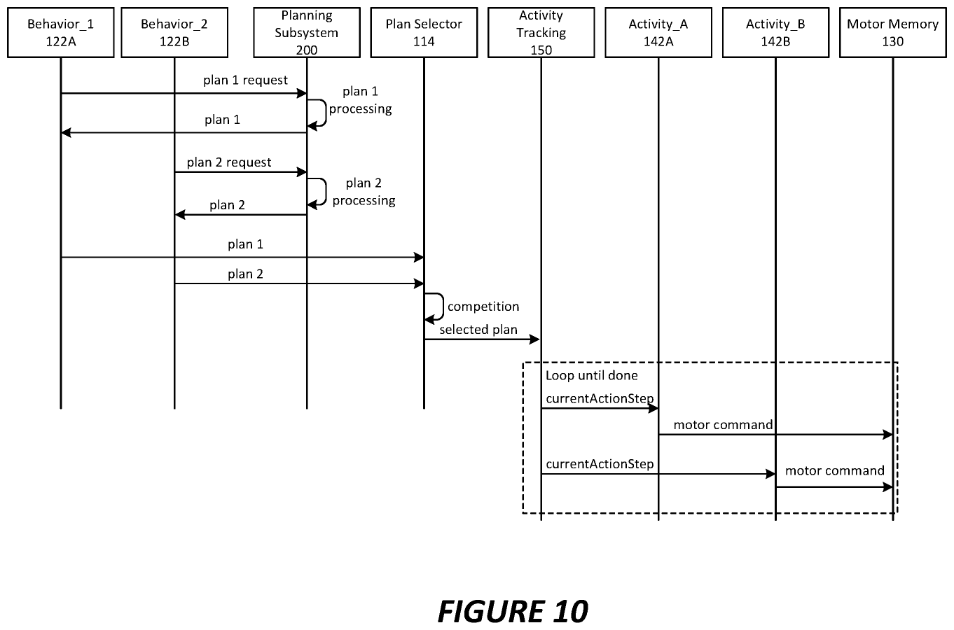

FIG. 10 illustrates operations of a dual-layer subsumption control system 100 including two sequential behavioral nodes 122A, 122B, two activity nodes 142A, 142B and one motor memory 130 according to some embodiments. Referring to FIGS. 5 and 10, sequential behavioral nodes 122A, 122B each submit plan requests to a planning subsystem 200. The planning subsystem 200 processes the requests, generates plans (plan 1 and plan 2), and transmits the plans to the respective sequential behavioral nodes 122A, 122B. The sequential behavioral nodes 122A, 122B submit the plans to a dynamic subsumption system, namely, plan selector node 114 of an imagination memory 110, where the plans complete for execution. The plan selector node 114 in the imagination memory 110 selects a plan for execution and transmits the selected plan to the activity selection subsystem 140 (FIG. 5). The activity tracking node 150 is also notified of the selected plan. Within the activity selection subsystem 140, the activity nodes 142A, 142B receive the selected plan, obtain the current action step from the activity tracking node 150, and responsively generate motor commands. The motor commands are provided to an activity selector node 132 in a motor memory 130 which selects a motor command for execution according to a dynamic subsumption model.

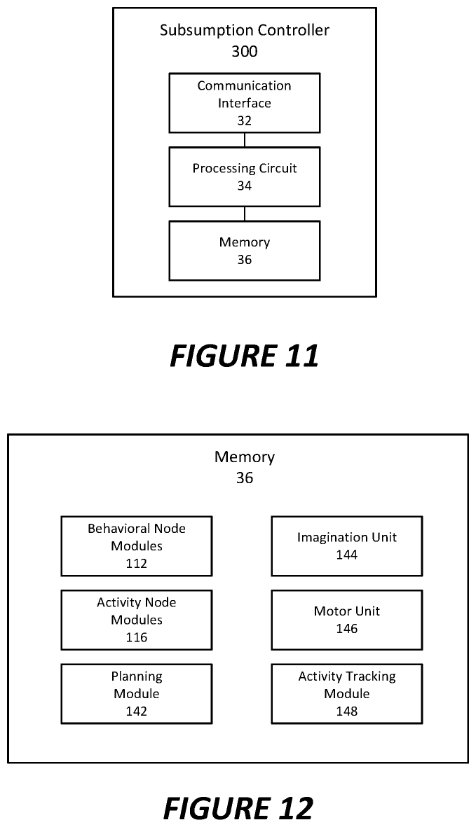

FIG. 11 illustrates some aspects of a subsumption controller 300 that may be used to implement the dual-layer subsumption control system 100, including the plan execution subsystem 120, the activity selection subsystem 140, and/or the planning subsystem 200. The subsumption controller 300 includes a processing circuit 34 for executing one or more modules to perform the operations described herein. A memory 36 is connected to the processing circuit 34 and stores one or more functional program modules for performing the operations described herein. The subsumption controller 300 further includes a communication interface 32. In some embodiments, the subsumption controller 300 may be embedded within an autonomous device, such as a robot. In other embodiments, the plan execution subsystem 120 may be located remotely from the device and may communicate with the device to receive sensor inputs and transmit motor commands via the communication interface 32.

FIG. 12 illustrates various functional modules that may be stored in the memory 36 for performing the operations described herein. In particular, the memory 36 may store one or more behavioral node modules 112 for controlling the operation of the sequential behavioral nodes 122, one or more activity node modules for controlling the operation of the activity nodes 142, a planning module 142 for controlling operation of the planning node 200, an imagination unit 144 for controlling operation of the imagination memory 110, a motor unit 146 for controlling operation of the motor memory 130 and an activity tracking module 148 for controlling operation of the activity tracking node 150. The modules illustrated in FIG. 12 may be embodied as computer program instructions stored in a non-transitory computer-readable medium.

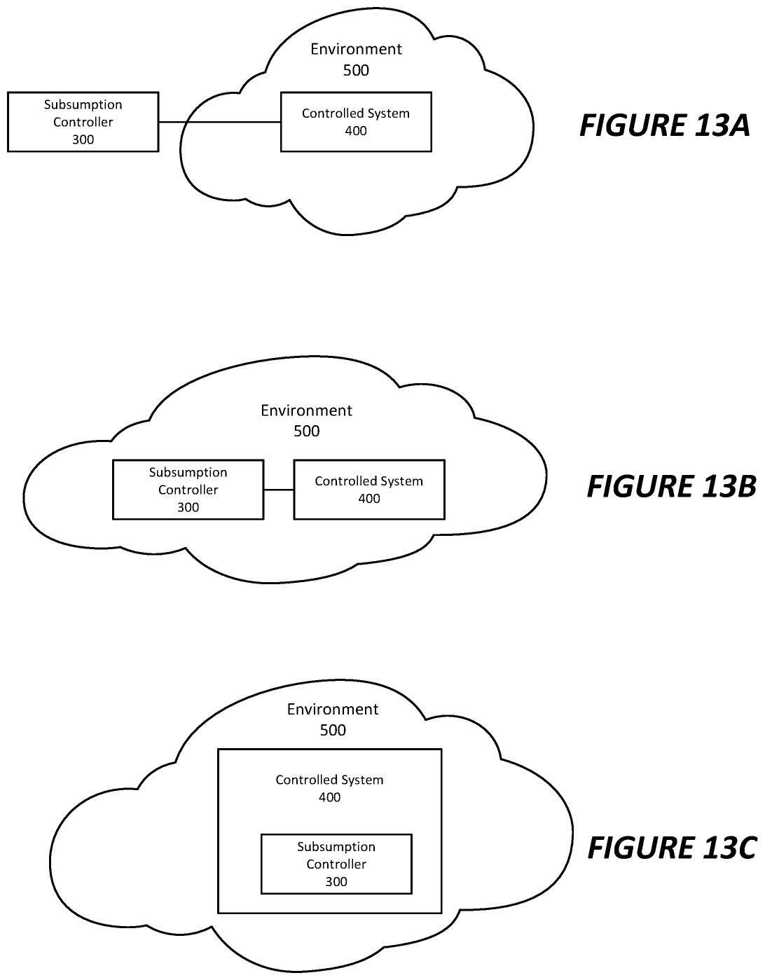

FIGS. 13A to 13C illustrate various ways in which a dual-layer subsumption controller 300 according to some embodiments can be deployed to control a controlled system 400 within an environment 500. The controlled system 400 can be, for example, a robot or other autonomous vehicle, such as a drone, a manufacturing system, a communication system, a computer network, or any other system that controllably interacts with an environment 500. The environment 500 may be a manufacturing floor, a natural environment, a communication medium, a warehouse, or any other physical environment with which controlled a system interacts.

As shown in FIG. 13A, the subsumption controller 300 may reside outside the environment 500 and control the controlled system 400 remotely, such as via a wireless communication link. As shown in FIG. 13B, the subsumption controller 300 may reside within the environment 500 but still control the controlled system 400 remotely via a wired or wireless communication link. As shown in FIG. 13C, the subsumption controller 300 may be embedded within the controlled system 400.

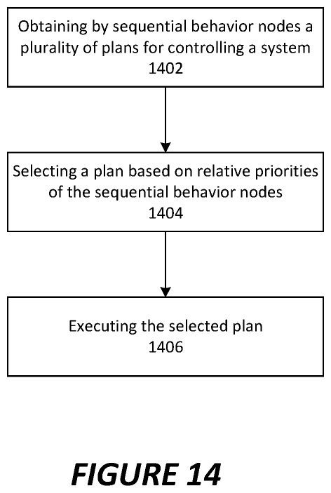

FIG. 14 is a flowchart illustrating operations according to some embodiments. Referring to FIG. 14, a method for controlling operation of a system that interacts with an environment includes obtaining (block 1402), by a plurality of sequential behavioral nodes, a plurality of plans for controlling the system, each plan comprising a sequence of activities to be performed by the system. The method selects (block 1404) one of the respective plans for execution based on relative priorities of the sequential behavioral nodes, and executes (1406) the selected plan.

Executing the selected plan may include transmitting the selected plan to an activity selection subsystem comprising a plurality of activity nodes, at least one of the activity nodes being associated with an activity in the sequence of activities included in the selected plan, and generating, by at least one of the activity nodes, a control signal for controlling an actuator of the system to perform the associated activity.

The method may further include identifying a current activity that is being performed by the system, and transmitting the identity of the current activity to the activity nodes.

The activity selection subsystem may include an activity selector node that receives control signals from a plurality of the activity nodes, selects one of the control signals based on relative priorities of the activity nodes, and applies the selected control signal to the actuator. The method may include generating plans in response to plan requests from the

sequential behavioral nodes, and transmitting the generated plans to the sequential behavioral nodes.

The method may include receiving the plan requests from the sequential behavioral nodes at a plan selector node, selecting one of the plan requests; and submitting the selected plan request to a planning subsystem. Selecting a plan request may include selecting a plan request for submission to the planning system based on relative priorities of the sequential behavioral nodes.

Some embodiments provide a subsumption-based controller for controlling operation of a system that interacts with an environment. The controller includes a plan execution subsystem comprising a plurality of sequential behavioral nodes, each configured to generate a respective plan for controlling the system, each respective plan comprising a sequence of activities to be performed by the system, a plan selector node configured to select one of the respective plans for execution, wherein the plan selector node selects the one of the respective plans for execution based on relative priorities of the sequential behavioral nodes; and an activity selection subsystem that receives the selected plan and executes the selected plan. The activity selection subsystem comprises a plurality of activity nodes, at least one of the activity nodes being associated with an activity in the sequence of activities included in the selected plan; and in response to the plan, the at least one of the activity nodes generates a control signal for controlling an actuator of the system to perform the associated activity.

The subsumption-based controller may further include an activity tracking node that receives the selected plan, identifies a current activity that is being performed by the system, and transmits the identity of the current activity to the activity selection subsystem.

The activity selection subsystem may include an activity selector node that receives control signals from a plurality of the activity nodes, selects one of the control signals based on relative priorities of the activity nodes, and applies the selected control signal to the actuator.

The subsumption-based controller may further include a planning subsystem that receives plan requests from the sequential behavioral nodes, generates plans in response to the plan requests, and transmits the generated plans to the sequential behavioral nodes.

The subsumption-based controller may further include a plan request selector node. The sequential behavioral nodes submit respect plan requests to the plan request selector node, and the plan request selector node selects one of the plan requests and submits the selected plan request to the planning subsystem.

The plan request selector node may select a plan request for submission to the planning subsystem based on relative priorities of the sequential behavioral nodes. The relative priorities of the sequential behavioral nodes may be established statically ahead of time or dynamically at run time.

The system may include a robotic system, a manufacturing system and/or a communication system. The actuator may include a motor. The subsumption-based controller may be embedded within the system or provided outside the system to control the system remotely.

1-21. (canceled)

22. A subsumption-based controller for controlling operation of a system that interacts with an environment, comprising:
a plan execution subsystem comprising a plurality of sequential behavioral nodes, each configured to generate a respective plan for controlling the system, each respective plan comprising a sequence of activities to be performed by the system;
a plan selector node configured to select one of the respective plans for execution, wherein the plan selector node selects the one of the respective plans for execution based on relative priorities of the sequential behavioral nodes; and
an activity selection subsystem that receives the selected plan and executes the selected plan;
wherein the activity selection subsystem comprises a plurality of activity nodes, at least one of the activity nodes being associated with an activity in the sequence of activities included in the selected plan; and
wherein, in executing the plan, the at least one of the activity nodes generates a control signal for controlling an actuator of the system to perform the associated activity.

23. The subsumption-based controller of claim 22, further comprising:
an activity tracking node that receives the selected plan, identifies a current activity that is being performed by the system, and transmits the identity of the current activity to the activity selection subsystem.

24. The subsumption-based controller of claim 22, wherein the activity selection subsystem comprises an activity selector node that receives control signals from the plurality of the activity nodes, selects one of the control signals based on relative priorities of the activity nodes, and applies the selected control signal to the actuator.

25. The subsumption-based controller of claim 22, further comprising:
a planning subsystem that receives plan requests from the sequential behavioral nodes, generates plans in response to the plan requests, and transmits the generated plans to the sequential behavioral nodes.

26. The subsumption-based controller of claim 25, further comprising:
a plan request selector node;
wherein the sequential behavioral nodes submit respect plan requests to the plan request selector node; and
the plan request selector node selects one of the plan requests and submits the selected plan request to the planning subsystem.

27. The subsumption-based controller of claim 26, wherein the plan request selector node selects a plan request for submission to the planning subsystem based on relative priorities of the sequential behavioral nodes.

28. The subsumption-based controller of claim 22, wherein the relative priorities of the sequential behavioral nodes are established at run time.

29. The subsumption-based controller of claim 22, wherein the system comprises a robotic system, a manufacturing system and/or a communication system.

30. The subsumption-based controller of claim 29, wherein the environment comprises a manufacturing floor, a natural environment, and/or a communication medium.

31. The subsumption-based controller of claim 22, wherein the actuator comprises a motor.

32. The subsumption-based controller of claim 22, wherein the subsumption-based controller is embedded within the system.

33. A method for controlling operation of a system that interacts with an environment, comprising:
obtaining, by a plurality of sequential behavioral nodes, a plurality of plans for controlling the system, each plan comprising a sequence of activities to be performed by the system;
selecting one of the respective plans for execution based on relative priorities of the sequential behavioral nodes; and
executing the selected plan.

34. The method of claim 33, wherein executing the selected plan comprises:
transmitting the selected plan to an activity selection subsystem comprising a plurality of activity nodes, at least one of the activity nodes being associated with an activity in the sequence of activities included in the selected plan; and
generating, by at least one of the activity nodes, a control signal for controlling an actuator of the system to perform the associated activity.

35. The method of claim 33, further comprising:
identifying a current activity that is being performed by the system, and transmitting the identity of the current activity to the activity nodes.

36. The method of claim 33, wherein the activity selection subsystem comprises an activity selector node that receives control signals from a plurality of the activity nodes, selects one of the control signals based on relative priorities of the activity nodes, and applies the selected control signal to the actuator.

37. The method of claim 33, further comprising:
generating plans in response to plan requests from the sequential behavioral nodes, and transmitting the generated plans to the sequential behavioral nodes.

38. The method of claim 37, further comprising:
receiving the plan requests from the sequential behavioral nodes at a plan request selector node;
selecting one of the plan requests; and
submitting the selected plan request to a planning subsystem.

39. The method of claim 38, wherein selecting a plan request comprises selecting a plan request for submission to the planning system based on relative priorities of the sequential behavioral nodes.

40. The method of claim 33, wherein the relative priorities of the sequential behavioral nodes are established at run time.

41. A subsumption-based controller configured for operation of a system that interacts with an environment, the subsumption-based controller comprising:
processing circuit;
memory coupled with the processing circuit, wherein the memory includes instructions that when executed by the processing circuit causes the subsumption-based controller to perform operations comprising:
obtain by a plurality of sequential behavioral nodes, a plurality of plans for controlling the system, each plan comprising a sequence of activities to be performed by the system;
select one of the respective plans for execution based on relative priorities of the sequential behavioral nodes; and
execute the selected plan.
